(19) United States
(12) Patent Application Publication
(10) Pub. No.: US 2022/0334170 A1
(43) Pub. Date: Oct. 20, 2022

(54) METHOD AND SYSTEM FOR CHARACTERIZING IGBT MODULE AGING BASED ON MINER THEORY

(71) Applicant: WUHAN UNIVERSITY, Hubei (CN)

(72) Inventors: Yigang HE, Hubei (CN); Lie LI, Hubei (CN); Liulu HE, Hubei (CN); Xiao Wang, Hubei (CN)

(73) Assignee: WUHAN UNIVERSITY, Hubei (CN)

(21) Appl. No.: 17/493,859

(22) Filed: Oct. 5, 2021

(30) Foreign Application Priority Data
Apr. 20, 2021 (CN) 202110424633.5

(51) Int. Cl. G01R 31/26; G06F 30/20

(52) U.S. Cl. CPC G01R 31/2642; G01R 31/2619; G06F 30/20; G06F 2119/04

(57) ABSTRACT

The invention discloses a method and a system for characterizing IGBT module aging based on Miner theory, including first establishing a life prediction model with a junction temperature fluctuation Tⱼₘ and an average junction temperature ΔTⱼ as inputs; then measuring a chip junction temperature data of an IGBT module; recording the junction temperature fluctuation Tⱼₘ and the average junction temperature ΔTⱼ of each power cycle; performing one life prediction in each cycle; and taking a reciprocal of a predicted life corresponding to each cycle and adding them to obtain an aging characteristic parameter D of the IGBT module. The invention may more suitably characterize the aging degree of the IGBT, and has the advantages of monotonically increasing change trend and high resolution.

### CROSS-REFERENCE TO RELATED APPLICATION

This application claims the priority benefit of China application serial no. 202110424633.5, filed on Apr. 20, 2021. The entirety of the above-mentioned patent application is hereby incorporated by reference herein and made a part of this specification.

### BACKGROUND OF THE INVENTION

### Field of the Invention

The invention belongs to the technical field of IGBT module aging, and more specifically, relates to a method and a system for characterizing IGBT module aging based on Miner theory.

### Description of Related Art

The insulate-gate bipolar transistor (IGBT), as a new generation of semiconductor power switching device, has advantages such as low driving power and reduced saturation voltage, and is widely used in fields such as electrical, transportation, aerospace, and new energy. However, with the development of ultra-high voltage and ultra-high voltage techniques, the requirements for the capacity of IGBT are getting higher. The working environment of high voltage and high current puts forward higher requirements on the reliability of IGBT.

In order to analyze the aging and invalidity of the IGBT module, it is necessary to monitor the aging status of the module, identify and extract the aging characteristics in time, extract faulty components from the aging characteristics for fault analysis, and find out possible or existing issues in the module. The parameters of aging characterization include saturation voltage of turn-on collector-emitter, chip casing thermal resistance, chip junction temperature, gate threshold voltage, on time, off time, etc. However, there are many issues with the above parameters, mainly including: (1) the maintenance time of some parameters is short, and the requirements for the measurement circuit are high; (2) parameters are affected by aging status and junction temperature; (3) when working under high voltage and high current, implementation of online measurement of condition monitoring is challenging.

### SUMMARY OF THE INVENTION

In view of the above defects or improvement requirements of the prior art, the invention provides a method and a system for IGBT module aging characterization based on Miner theory, which has the advantages of low measurement difficulty and accurate aging characterization.

To achieve the above object, according to one aspect of the invention, a Kalman filter method for improving the spatial resolution of array grating positioning is provided, including:
S1: establishing a life prediction model with a junction temperature fluctuation Tⱼₘ and an average junction temperature ΔTⱼ as inputs;
S2: measuring a chip junction temperature data of an IGBT module;
S3: recording the junction temperature fluctuation Tⱼₘ and the average junction temperature ΔTⱼ of each power cycle;
S4: performing one life prediction in each power cycle based on the life prediction model;
S5: taking a reciprocal of a predicted life corresponding to each power cycle and adding them to obtain an aging characteristic parameter D of the IGBT module.

In some alternative embodiments, step S1 includes:
S1.1: performing a temperature cycle aging experiment on a group of IGBT modules of a same model, and controlling a temperature of an IGBT to prevent an aging of the IGBT modules from affecting their own temperature;
S1.2: establishing a life prediction model

$${N}_{f} = A Δ {T}_{j}^{α} {e}^{\frac{{E}_{a}}{{k}_{B} ( {T}_{jm} + 273 )}}$$

according to a junction temperature fluctuation Tⱼₘ and an average junction temperature ΔTⱼ of the IGBT modules and a corresponding working life N_{f}, wherein A and a are constants to be fitted, Eₐ is an activation energy, and k_{B} is Boltzmann constant.

In some alternative embodiments, step S2 includes:
S2.1: measuring a chip junction temperature of an IGBT module to be tested when the IGBT module is disconnected in a working state and recording the chip junction temperature as Tⱼₘₐₓ;
S2.2: measuring a chip junction temperature when the IGBT module is turned on and recording the chip junction temperature as Tⱼₘᵢₙ.

In some alternative embodiments, step S3 includes:
S3.1: recording a maximum junction temperature and a minimum junction temperature recorded in an i-th power cycle as Tⱼₘₐₓ₋ᵢ and Tⱼₘᵢₙ₋ᵢ respectively;
S3.2: calculating a junction temperature fluctuation of the i-th power cycle by ΔTⱼ₋ᵢ=Tⱼₘₐₓ₋ᵢ−Tⱼₘᵢₙ₋ᵢ;
S3.3: calculating an average junction temperature of the i-th power cycle by Tⱼₘ₋ᵢ=(Tⱼₘₐₓ₋ᵢ+Tⱼₘᵢₙ₋ᵢ)/2.

In some alternative embodiments, step S5 includes:
S5.1: calculating a corresponding working life N_{f-i} by the life prediction model according to the junction temperature fluctuation Tⱼₘ₋ᵢ and the average junction temperature ΔTⱼ₋ᵢ recorded in the i-th power cycle;
S5.2: taking a reciprocal of N_{f-i} and adding them up to a j-th power cycle (i≤j) with the formula

$${D}_{j} = {\sum }_{i = 1}^{j} \frac{1}{{N}_{f - i}} ;$$

S5.3: taking Dⱼ to characterize an aging degree of an IGBT during the j-th power cycle;
S5.4: when Dⱼ=1, according to Miner theory, the IGBT is considered to be invalid at this time.

According to another aspect of the invention, a system for characterizing IGBT module aging based on Miner theory is provided, including:
a life prediction model building module configured to establish a life prediction model that takes a junction temperature fluctuation Tⱼₘ and an average junction temperature ΔTⱼ as inputs;
a measurement module configured to measure a chip junction temperature data of an IGBT module;
a recording module configured to record a junction temperature fluctuation Tⱼₘ and an average junction temperature ΔTⱼ of each power cycle;
a life prediction module configured to perform one life prediction in each power cycle based on the life prediction model;
an aging characterization module configured to take a reciprocal of a predicted life corresponding to each power cycle and adding them to obtain an aging characteristic parameter D of the IGBT module.

In some alternative embodiments, the life prediction model building module is configured to perform a temperature cycling aging experiment on a group of IGBT modules of a same model, and to control a temperature of an IGBT to prevent an aging of the IGBT modules from affecting their own temperature; according to a junction temperature fluctuation Tⱼₘ and an average junction temperature ΔTⱼ of the IGBT modules and a corresponding working life N_{f}, a life prediction model

$${N}_{f} = A Δ {T}_{j}^{α} {e}^{\frac{{E}_{a}}{{k}_{B} ( {T}_{jm} + 273 )}}$$

is established, wherein A and α are constants to be fitted, Eₐ is an activation energy, and k_{B} is Boltzmann constant.

In some alternative embodiments, the measurement module is configured to measure a chip junction temperature for an IGBT module to be tested when the IGBT module is disconnected in a working state, which is recorded as Tⱼₘₐₓ; when the IGBT module is turned on, the chip junction temperature at this time is measured and recorded as Tⱼₘᵢₙ.

In some alternative embodiments, the recording module is configured to record a maximum junction temperature and a minimum junction temperature of an i-th power cycle as Tⱼₘₐₓ₋ᵢ and Tⱼₘᵢₙ₋ᵢ, respectively; a junction temperature fluctuation of the i-th power cycle is calculated by ΔTⱼ₋ᵢ=Tⱼₘₐₓ₋ᵢ−Tⱼₘᵢₙ₋ᵢ; and an average junction temperature of the i-th power cycle is calculated by Tⱼₘ₋ᵢ=(Tⱼₘₐₓ₋ᵢ+Tⱼₘᵢₙ₋ᵢ)/2.

In some alternative embodiments, the aging characterization module is configured to calculate a corresponding working life N_{f-i} from the life prediction model according to the junction temperature fluctuation Tⱼₘ₋ᵢ and the average junction temperature ΔTⱼ₋ᵢ recorded in the i-th power cycle; a reciprocal of N_{f-i} is taken and added up to a j-th power cycle (i≤j) with the formula

$${D}_{j} = {\sum }_{i = 1}^{j} \frac{1}{{N}_{f - i}} ;$$

Dⱼ is taken to characterize an aging degree of an IGBT during the j-th power cycle; when Dⱼ=1, according to Miner theory, it is considered that the IGBT is invalid at this time.

According to another aspect of the invention, a computer-readable storage medium is provided, wherein a computer program is stored thereon, and when the computer program is executed by a processor, the steps of any of the above methods are implemented.

Generally speaking, compared with the prior art, the above technical solutions conceived by the invention may achieve the following beneficial effects:

(1) compared with a traditional method for IGBT aging characterization, this method is monotonically increasing in value, which conforms to the basic principle of aging accumulation;

(2) this method has an objective rate of change throughout the aging cycle, and may accurately determine the aging stage of the IGBT during operation.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic flowchart of a method for characterizing IGBT module aging based on Miner theory provided by an embodiment of the invention.

FIG. 2 is a life prediction model provided by an embodiment of the invention.

### DESCRIPTION OF THE EMBODIMENTS

In order to make the objects, technical solutions, and advantages of the invention clearer, the invention is further described in detail below in conjunction with the accompanying figures and embodiments. It should be understood that the specific embodiments described herein are only used to explain the invention, and are not intended to limit the invention. In addition, the technical features involved in the various embodiments of the invention described below may be combined with each other as long as there is no conflict with each other.

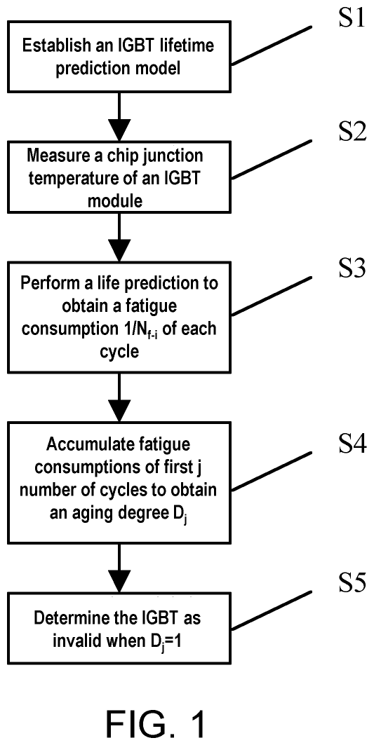

FIG. 1 shows a schematic flowchart of a method for characterizing IGBT module aging based on Miner theory provided by an embodiment of the invention, including the following steps:

S1: establishing a life prediction model with a junction temperature fluctuation Tⱼₘ and an average junction temperature ΔTⱼ as inputs;

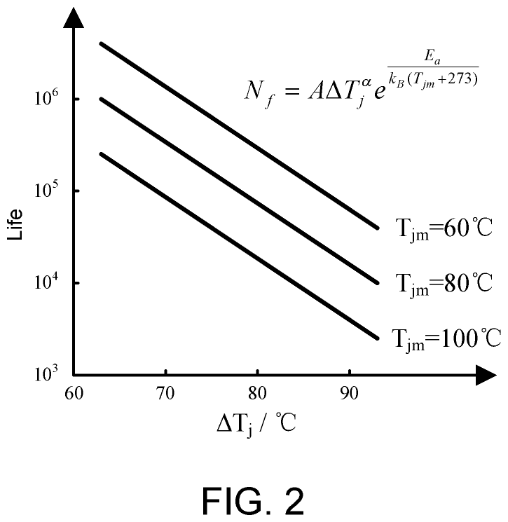

in an embodiment of the invention, as shown in FIG. 2, in step S1, the specific method of establishing the life prediction model with the junction temperature fluctuation Tⱼₘ and the average junction temperature ΔTⱼ as inputs is as follows:

S1.1: performing a temperature cycle aging experiment on a group of IGBT modules of a same model, and controlling a temperature of an IGBT via a thermostat to prevent an aging of the IGBT modules from affecting their own temperature;

wherein a temperature of the IGBT is controlled using a thermostat. At this time, the IGBT does not generate heat by itself, so the junction temperature fluctuation and the average junction temperature during the aging process may be strictly controlled to make the prediction result more accurate.

S1.2: establishing a life prediction model

$${N}_{f} = A Δ {T}_{j}^{α} {e}^{\frac{{E}_{a}}{{k}_{B} ( {T}_{jm} + 273 )}}$$

according to the junction temperature fluctuation Tⱼₘ and the average junction temperature ΔTⱼ of the IGBT modules and a corresponding working life N_{f}, wherein A and α are constants to be fitted, Eₐ is an activation energy, Eₐ=9.89×10⁻²⁰ J, k_{B} is Boltzmann constant, and k_{B}=1.38×10⁻²³ J/K.

S2: measuring a chip junction temperature data of the IGBT modules using an infrared thermometer;

in an embodiment of the invention, in step S2, the specific method of measuring the chip junction temperature data of the IGBT modules using an infrared thermometer is as follows:

S2.1: measuring a chip junction temperature of an IGBT module to be tested when the IGBT module is disconnected in a working state and recording the chip junction temperature as Tⱼₘₐₓ;

since an IGBT chip is constantly changing during operation, when the IGBT is turned on, due to the influence of the on voltage drop and the working current, the IGBT chip itself generates heat, thus causing junction temperature to rise. When the IGBT is disconnected, since the working current is basically zero, the chip basically does not generate heat, and chip temperature is dropped at this time. Therefore, when the IGBT is switched from on to off, the IGBT has maximum junction temperature, and when the IGBT is switched from off to on, the IGBT has minimum junction temperature.

S2.2: measuring a chip junction temperature when the IGBT module is turned on and recording the chip junction temperature as Tⱼₘᵢₙ.

S3: recording the junction temperature fluctuation Tⱼₘ and the average junction temperature ΔTⱼ of each power cycle;

in an embodiment of the invention, in step S3, the specific method of recording the junction temperature fluctuation Tⱼₘ and the average junction temperature ΔTⱼ of each power cycle is as follows:

S3.1: recording a maximum junction temperature and a minimum junction temperature recorded in an i-th power cycle as Tⱼₘₐₓ₋ᵢ and Tⱼₘᵢₙ₋ᵢ respectively;

S3.2: calculating a junction temperature fluctuation of the i-th power cycle by ΔTⱼ₋ᵢ=Tⱼₘₐₓ₋ᵢ−Tⱼₘᵢₙ₋ᵢ;

S3.3: calculating an average junction temperature of the i-th power cycle by ΔTⱼₘ₋ᵢ=(Tⱼₘₐₓ₋ᵢ+Tⱼₘᵢₙ₋ᵢ)/2.

S4: performing one life prediction in each power cycle based on the life prediction model;

S5: taking a reciprocal of a predicted life corresponding to each power cycle and adding them to obtain an aging characteristic parameter D of the IGBT module.

In an embodiment of the invention, in step S5, the specific method of taking the reciprocal of the predicted life corresponding to each power cycle and adding them to obtain the aging characterization parameter D of the IGBT module is as follows:

S5.1: calculating a corresponding working life N_{f-i} by the life prediction model according to the junction temperature fluctuation Tⱼₘ₋ᵢ and the average junction temperature ΔTⱼ₋ᵢ recorded in the i-th power cycle;

S5.2: taking a reciprocal of N_{f-i} and adding them up to a j-th power cycle (i≤j) with the formula

$${D}_{j} = {\sum }_{i = 1}^{j} \frac{1}{{N}_{f - i}} ;$$

S5.3: taking Dⱼ to characterize an aging degree of an IGBT during the j-th power cycle;

S5.4: when Dⱼ=1, according to Miner theory, the IGBT is considered to be invalid at this time.

The Miner theory is specifically: if the number of cycles of the material under an alternating stress σ₁ is n₁, the number of cycles under σ₂ is n₂ . . . and the number of cycles under σ_{N} is n_{N}. According to the life prediction model, it may be found that the invalid cycle life corresponding to σ₁ is N_{f-1}, the invalid cycle life corresponding to σ₂ is N_{f-2} . . . and the invalid cycle life corresponding to σ_{N} is N_{f-N}. According to Miner theory, when

$${\sum }_{i = 1}^{j} \frac{{n}_{i}}{{N}_{f - i}} = 1 ,$$

it may be considered that the material is invalid. Using an analogy method to refine the theory, it is considered that the fatigue degree consumed by each cycle is 1/Nᵢ, and the current fatigue degree consumed by all cycles is recorded and accumulated to obtain the current aging degree of the IGBT module.

It should be noted that, according to implementation needs, each step/component described in the present application may be split into more steps/components, or two or a plurality of steps/components or partial operations of the steps/components may be combined into new steps/components to achieve the object of the invention.

It is easy for those skilled in the art to understand that the above are only preferred embodiments of the invention and are not intended to limit the invention. Any modification, equivalent replacement, and improvement made within the spirit and principles of the invention should be included in the protection scope of the invention.

What is claimed is:

1. A method for characterizing IGBT module aging based on Miner theory, comprising:
S1: establishing a life prediction model with a junction temperature fluctuation and an average junction temperature as inputs;
S2: measuring a data of a chip junction temperature of an IGBT module;
S3: recording the junction temperature fluctuation and the average junction temperature of each power cycle;
S4: performing one life prediction in each power cycle based on the life prediction model;
S5: taking a reciprocal of a predicted life corresponding to each power cycle and adding them to obtain an aging characteristic parameter of the IGBT module.

2. The method of claim 1, wherein step S1 comprises:
S1.1: performing a temperature cycle aging experiment on a group of IGBT modules of a same model, and controlling a temperature of an IGBT to prevent an aging of the IGBT modules from affecting their own temperature;
S1.2: establishing the life prediction model
$${N}_{f} = A Δ {T}_{j}^{α} {e}^{\frac{{E}_{a}}{{k}_{B} ( {T}_{jm} + 273 )}}$$
according to the junction temperature fluctuation Tⱼₘ and the average junction temperature ΔTⱼ of the IGBT modules and a corresponding working life N_{f}, wherein A and α are constants to be fitted, Eₐ is an activation energy, and k_{B} is Boltzmann constant.

3. The method of claim 2, wherein step S2 comprises:
S2.1: measuring the chip junction temperature of an IGBT module to be tested when the IGBT module is disconnected in a working state and recording the chip junction temperature as Tⱼₘₐₓ;
S2.2: measuring the chip junction temperature when the IGBT module is turned on and recording the chip junction temperature as Tⱼₘᵢₙ.

4. The method of claim 3, wherein step S3 comprises:
S3.1: a maximum junction temperature of an i-th power cycle record is Tⱼₘₐₓ₋ᵢ, and a minimum junction temperature of the i-th power cycle record is Tⱼₘᵢₙ₋ᵢ;
S3.2: calculating the junction temperature fluctuation ΔTⱼ₋ᵢ of the i-th power cycle by ΔTⱼ₋ᵢ=Tⱼₘₐₓ₋ᵢ−Tⱼₘᵢₙ₋ᵢ;
S3.3: calculating the average junction temperature Tⱼₘ₋ᵢ of the i-th power cycle by Tⱼₘ₋ᵢ=(Tⱼₘₐₓ₋ᵢ+Tⱼₘᵢₙ₋ᵢ)/2.

5. The method of claim 4, wherein step S5 comprises:
S5.1: calculating a corresponding working life N_{f-i} by the life prediction model according to the junction temperature fluctuation Tⱼₘ₋ᵢ and the average junction temperature ΔTⱼ₋ᵢ recorded in the i-th power cycle;
S5.2: taking a reciprocal of N_{f-i} and adding them up to a j-th power cycle (i≤j) to obtain the aging characteristic parameter
$${D}_{j} = {\sum }_{i = 1}^{j} \frac{1}{{N}_{f - i}}$$
of the IGBT module;
S5.3: taking Dⱼ to characterize an aging degree of the IGBT during the j-th power cycle;
S5.4: when Dⱼ=1, according to the Miner theory, the IGBT is considered to be invalid at this time.

6. A system for characterizing IGBT module aging based on the Miner theory, comprising:
a life prediction model building module configured to establish a life prediction model that takes a junction temperature fluctuation and an average junction temperature as inputs;
a measurement module configured to measure a data of a chip junction temperature of an IGBT module;
a recording module configured to record the junction temperature fluctuation and the average junction temperature of each power cycle;
a life prediction module configured to perform one life prediction in each power cycle based on the life prediction model;
an aging characterization module configured to take a reciprocal of a predicted life corresponding to each power cycle and add them to obtain an aging characteristic parameter of the IGBT module.

7. The system of claim 6, wherein the life prediction model building module is configured to perform a temperature cycling aging experiment on a group of IGBT modules of a same model, and control a temperature of an IGBT to prevent an aging of the IGBT modules from affecting their own temperature; according to the junction temperature fluctuation Tⱼₘ and the average junction temperature ΔTⱼ of the IGBT modules and a corresponding working life N_{f}, the life prediction model
$${N}_{f} = A Δ {T}_{j}^{α} {e}^{\frac{{E}_{a}}{{k}_{B} ( {T}_{jm} + 273 )}}$$
is established, wherein A and α are constants to be fitted, Eₐ is an activation energy, and k_{B} is Boltzmann constant.

8. The system of claim 7, wherein the recording module is configured to record a maximum junction temperature of an i-th power cycle as Tⱼₘₐₓ₋ᵢ, and record a minimum junction temperature of the i-th power cycle as Tⱼₘᵢₙ₋ᵢ; the junction temperature fluctuation ΔTⱼ₋ᵢ of the i-th power cycle is calculated by ΔTⱼ₋ᵢ=Tⱼₘₐₓ₋ᵢ−Tⱼₘᵢₙ₋ᵢ; and the average junction temperature Tⱼₘ₋ᵢ of the i-th power cycle is calculated by Tⱼₘ₋ᵢ=(Tⱼₘₐₓ₋ᵢ+Tⱼₘᵢₙ₋ᵢ)/2.

9. The system of claim 8, wherein the aging characterization module is configured to calculate a corresponding working life N_{f-i} from the life prediction model according to the junction temperature fluctuation Tⱼₘ₋ᵢ and the average junction temperature ΔTⱼ₋ᵢ recorded in the i-th power cycle; a reciprocal of N_{f-i} is taken and added up to a j-th power cycle (i≤j) to obtain the aging characterization parameter
$${D}_{j} = {\sum }_{i = 1}^{j} \frac{1}{{N}_{f - i}}$$
of the IGBT modules; Dⱼ is taken to characterize an aging degree of the IGBT during the j-th power cycle; and when Dⱼ=1, according to the Miner theory, it is considered that the IGBT is invalid at this time.

10. A computer-readable storage medium, with a computer program stored thereon, wherein the computer program implements the steps of the method of claim 1 when the computer program is executed by a processor.

11. A computer-readable storage medium, with a computer program stored thereon, wherein the computer program implements the steps of the method of claim 2 when the computer program is executed by a processor.

12. A computer-readable storage medium, with a computer program stored thereon, wherein the computer program implements the steps of the method of claim 3 when the computer program is executed by a processor.

13. A computer-readable storage medium, with a computer program stored thereon, wherein the computer program implements the steps of the method of claim 4 when the computer program is executed by a processor.

14. A computer-readable storage medium, with a computer program stored thereon, wherein the computer program implements the steps of the method of claim 5 when the computer program is executed by a processor.
